(19) United States
(12) Patent Application Publication
(10) Pub. No.: US 2020/0256445 A1
(43) Pub. Date: Aug. 13, 2020

(54) STRAIN WAVE GEARING APPARATUS AND ACTUATOR OF VARIABLE COMPRESSION RATIO MECHANISM FOR INTERNAL COMBUSTION ENGINE

(71) Applicant: HITACHI AUTOMOTIVE SYSTEMS, LTD., Hitachinaka-shi, Ibaraki (JP)

(72) Inventors: Ken Bryan IKEGUCHI, Ayase-shi, Kanagawa (JP); Masato MANAKO, Atsugi-shi, Kanagawa (JP)

(73) Assignee: HITACHI AUTOMOTIVE SYSTEMS, LTD., Hitachinaka-shi, Ibaraki (JP)

(21) Appl. No.: 16/642,791

(22) PCT Filed: Sep. 13, 2018
(86) PCT No.: PCT/JP2018/033907

§ 371 Date: Feb. 27, 2020

(30) Foreign Application Priority Data
Sep. 22, 2017 (JP) 2017-182310

(51) Int. Cl. F16H 49/00; F02B 75/04

(52) U.S. Cl. CPC F16H 49/001; F02B 75/04

(57) ABSTRACT

A strain wave gearing apparatus includes a rigid internal gear including a plurality of teeth on an inner periphery thereof, a cylindrical flexible external gear including a plurality of teeth on an outer periphery thereof, and a wave generator having an elliptic outer periphery. A contact of the outer periphery of the wave generator with an inner periphery of the external gear causes the external gear to be elliptically distorted and meshed with the internal gear at a part of the teeth of the external gear in a direction of a major axis. A rotation of the wave generator causes a position of the mesh to be moved in a circumferential direction. The elliptic outer periphery of the wave generator includes a major axis in common with a reference ellipse, and is different from the reference ellipse in terms of a shape of at least a part thereof in the circumferential direction. The elliptic outer periphery is located a long distance away from a rotational axis compared to the reference ellipse in at least a partial region in the circumferential direction that does not include an intersection point with the major axis.

### TECHNICAL FIELD

The present invention relates to a strain wave gearing apparatus and an actuator of a variable compression ratio mechanism for an internal combustion engine.

### BACKGROUND ART

As a strain wave gearing apparatus, for example, the invention discussed in PTL 1 has been known. This invention has been invented by C. W. Musser, and is configured in such a manner that a planetary gear classified as a K-H-V type planetary gear is elliptically distorted to be meshed at an end of a major axis thereof, and a rotation of the major axis is treated as one system of an apparatus. An outline thereof will be described now. The strain wave gearing apparatus is configured in such a manner that a thin cylindrical elastic external gear and a rigid internal gear, on which the number of teeth thereof is larger than the elastic external gear by an even number of teeth, are disposed coaxially, and the elastic external gear is elliptically distorted by a wave generator fittedly inserted inside the elastic external gear. The major axis of the ellipse is rotated in synchronization with a rotational movement input to the wave generator, and the elastic external gear is kept deformed in a state that a degree of rotational freedom in a circumferential direction is provided thereto and therefore carries out a deformation movement while changing a position of mesh with the rigid internal gear on the major axis of the ellipse. At the time of this deformation movement, due to the difference in the number of teeth between the elastic external teeth and the rigid internal teeth, a difference in circumferential relative position between the rigid internal gear and the elastic external gear is changed and this difference is output as a slowed rotation. As a variable compression ratio mechanism for an internal combustion engine, for example, the invention discussed in PTL 2 has been known. The variable compression ratio mechanism includes a control shaft and an actuator that changes a rotational position of this control shaft. A strain wave gearing apparatus is mounted on the actuator as a speed reducer that slows down the rotational speed of the electric motor to then transmit it to the above-described control shaft.

### CITATION LIST

### Patent Literature

[PTL 1] United States Patent No. 2906143

[PTL 2] Japanese Patent Application Public Disclosure No. 2012-251446

### SUMMARY OF INVENTION

### Technical Problem

The improvement of the basic performance of the strain wave gearing apparatus has been attempted by changing the shape of the tooth surface. However, adjusting the shape of the tooth surface according to the tooth movement has necessitated a considerable correction to the tooth profile, but there has been a limit on an amount of the correction and this has also led to a limit on the improvement of the basic performance of the strain wave gearing apparatus.

### Solution to Problem

An object of the present invention is to provide a strain wave gearing apparatus and an actuator of a variable compression ratio mechanism for an internal combustion engine capable of improving the basic performance.

According to one aspect of the present invention, a strain wave gearing apparatus includes a wave generator including an elliptic outer periphery. The elliptic outer periphery includes a major axis in common with a reference ellipse, and a shape of at least a part thereof in a circumferential direction is different from the reference ellipse.

Therefore, the strain wave gearing apparatus according to the one aspect of the present invention can harmonize a movement trajectory of the tooth with the shape of the tooth of the mesh partner, thereby improving the basic performance thereof.

### BRIEF DESCRIPTION OF DRAWINGS

FIG. 1 is a schematic view of an internal combustion engine including a variable compression ratio mechanism according to a first embodiment.

FIG. 2 is a cross-sectional view of an actuator of the variable compression ratio mechanism according to the first embodiment.

FIG. 3 is an exploded isometric view of a strain wave gearing apparatus according to the first embodiment.

FIG. 4 is a schematic view illustrating a mesh state between a flexible external gear and a rigid internal gear according to the first embodiment.

FIG. 5 illustrates a movement trajectory of an external tooth of the flexible external gear according to the first embodiment.

FIG. 6 is a schematic view illustrating a mesh state between the flexible external gear and the rigid internal gear after a shape of an outer periphery of a wave generator according to the first embodiment is corrected.

FIG. 7 is a schematic view illustrating a mesh state between the flexible external gear and the rigid internal gear before the shape of the outer periphery of the wave generator is corrected.

FIG. 8 schematically illustrates the shape of the outer periphery of the wave generator according to the first embodiment after the correction compared to a reference ellipse.

### DESCRIPTION OF EMBODIMENTS

### First Embodiment

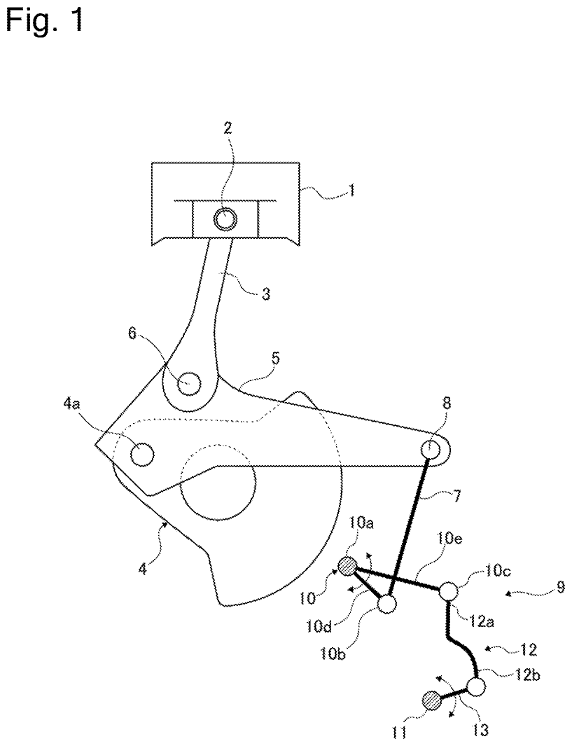

First, a configuration will be described. A variable compression ratio mechanism for an internal combustion engine according to a present embodiment has a basic configuration similar to the configuration illustrated in FIG. 1 of Japanese Patent Application Public Disclosure No. 2011-169152, and therefore will be described briefly.

The entire disclosure of Japanese Patent Application Public Disclosure No. 2011-169152 including the specification, the claims, the drawings, and the abstract is incorporated herein by reference in its entirety.

As illustrated in FIG. 1, an upper end portion of an upper link 3 is rotatably coupled with a piston 1 via a piston pin 2. The piston 1 reciprocates in a cylinder of a cylinder block of the internal combustion engine. A lower link 5 is rotatably coupled with a lower end portion of the upper link 3 via a coupling pin 6. A crankshaft 4 is rotatably coupled with the lower link 5 via a crank pin 4a. Further, an upper end portion of a first control link 7 is rotatably coupled with the lower link 5 via a coupling pin 8. A lower end portion of the first control link 7 is coupled with a coupling mechanism 9 including a plurality of link members. The coupling mechanism 9 includes a first control shaft 10, a second control shaft 11, and a second control link 12.

The first control shaft 10 extends in parallel with the crankshaft 4, which extends in a direction of a cylinder bank inside the internal combustion engine. The first control shaft 10 includes a first journal portion 10a, a control eccentric shaft portion 10h, and an eccentric shaft portion 10c. The first journal portion 10a is rotatably supported on a main body of the internal combustion engine. A lower end portion of the first control link 7 is rotatably coupled with the control eccentric shaft portion 10b. One end portion 12a of the second control link 12 is rotatably coupled with the eccentric shaft portion 10c. A first arm portion 10d has one end portion coupled with the first journal portion 10a and the other end portion coupled with the lower end portion of the first control link 7. The control eccentric shaft portion 10b is located at a position eccentric with respect to the first journal portion 10a by a predetermined amount. A second arm portion 10e has one end portion coupled with the first journal portion 10a and the other end portion coupled with the one end portion 12a of the second control link 12. The eccentric shaft portion 10c is located at a position eccentric with respect to the first journal portion 10a by a predetermined amount. One end portion of an arm link 13 is rotatably coupled with the other end portion 12b of the second control link 12. The second control shaft 11 is coupled with the other end of the arm link 13 so as to be unable to relatively move. The second control shaft 11 is rotatably supported on the inside of a housing 20, which will be described below, via a plurality of journal portions.

The second control link 12 couples the first control shaft 10 and the second control shaft 11 with each other. The second control link 12 is prepared in the form of a lever, and the one end portion 12a coupled with the eccentric shaft portion 10c is generally linearly formed. On the other hand, the other end portion 12b of the second control link 12 with the arm link 13 coupled therewith is formed in a curved manner. An insertion hole extends through a distal end portion of the one end portion 12a. The eccentric shaft portion 10c is rotatably inserted through the insertion hole. The arm link 13 and the second control shaft 11 are different members. A rotational position of the second control shaft 11 is changed by a torque transmitted from an electric motor 22 via a strain wave gearing apparatus 21 as a speed reducer (a strain wave gearing speed reducer), which is a part of an actuator A. When the rotational position of the second control shaft 11 is changed, the first control shaft 10 is rotated via the second control link 12 to change the position of the lower end portion of the first control link 7. This results in a change in an orientation of the lower link 5 and thus a change in a stroke position and a stroke amount of the piston 1 in the cylinder, thereby leading to a change in an engine compression ratio according thereto.

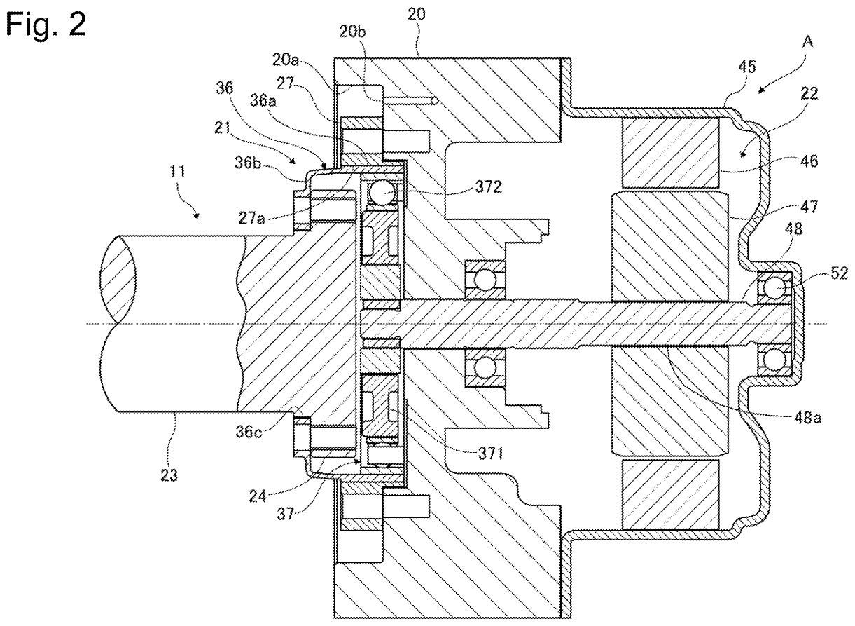

Next, a configuration of the actuator A of the variable compression ratio mechanism according to the present embodiment will be described. As illustrated in FIG. 2, the actuator A includes the electric motor 22, the strain wave gearing apparatus 21, the housing 20, and the second control shaft 11. The electric motor 22 is, for example, a brushless motor, and includes a motor casing 45, a coil 46, a rotor 47, and a motor output shaft 48. The motor casing 45 has a bottomed cylindrical shape. The coil 46 is fixed to an inner peripheral surface of the motor casing 45. The rotor 47 is rotatably provided inside the coil 46. The motor output shaft 48 includes one end portion 48a fixed to a center of the rotor 47. The motor output shaft 48 is rotatably supported by a ball bearing 52 mounted on a bottom portion of the motor casing 45. The second control shaft 11 is rotatably supported on the housing 20. The second control shaft 11 includes a shaft portion main body 23 and a fixation flange 24. The shaft portion main body 23 extends axially. The fixation flange 24 is located at one end portion of the shaft portion main body 23, and erects radially outward. The shaft portion main body 23 and the fixation flange 24 are integrally formed from a ferrous metallic material. A plurality of bolt insertion holes is formed on an outer peripheral portion of the fixation flange 24 at even intervals in a circumferential direction. Bolts are inserted through these bolt insertion holes. The bolts are coupled with a flange portion 36b of a flexible external gear 36 of the strain wave gearing apparatus 21.

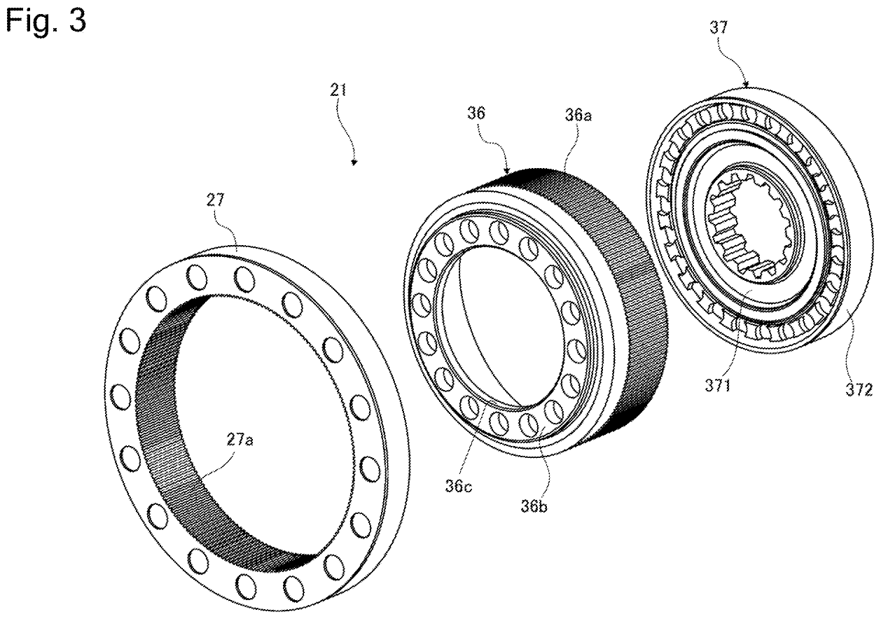

Next, a configuration of the strain wave gearing apparatus 21 according to the present embodiment will be described. The strain wave gearing apparatus 21 is mounted on the distal end side of the electric motor 22, and is contained inside the housing 20. The strain wave gearing apparatus 21 is fixed to the housing 20 with use of a bolt. The strain wave gearing apparatus 21 is contained inside an opening groove 20a of the housing 20. A supply hole 20b is opened inside the opening groove portion 20a and above the strain wave gearing apparatus 21 in the direction of gravitational force. The supply hole 20b is used to supply lubrication oil from a not-illustrated hydraulic source or the like. When the lubrication oil is supplied from the supply hole 20b, the lubrication oil is dropped to the strain wave gearing apparatus 21 located below it, thereby lubricating between the individual rotational elements. As illustrated in FIG. 3, the strain wave gearing apparatus 21 includes a rigid internal gear 27, a flexible external gear 36, and a wave generator 37.

The rigid internal gear 27 is a rigid annular member including a plurality of internal teeth 27a on an inner periphery thereof. The flexible external gear 36 is disposed on a radially inner side of the rigid internal gear 27. The flexible external gear 36 is a cylindrical member made from a metallic material, and includes a thin distortedly deformable cylindrical portion (a barrel portion) and a bottom portion. The flexible external gear 36 includes external teeth 36a on an outer periphery thereof. The external teeth 36a can be meshed with the internal teeth 27a of the rigid internal gear 27. The number of external teeth 36a is smaller than the number of internal teeth 27a by an even number of teeth (two teeth). An insertion hole 36c is provided on an inner periphery of the flange portion 36b formed on the bottom portion of the flexible external gear 36. The second control shaft 11 is inserted through the insertion hole 36c. The second control shaft 11 is inserted into the insertion hole 36c from the cylindrical portion side of the flexible external gear 36, and the fixation flange 24 of the second control shaft 11 and the flange portion 36b are coupled with each other with use of the bolts. The inner periphery of the insertion hole 36c is supported by the second control shaft 11, which ensures the rigidity of the bottom portion of the flexible external gear 36.

The wave generator 37 has an elliptic outer periphery, and this outer periphery is in contact with an inner periphery of the flexible external gear 36 throughout an entire range in a circumferential direction. The wave generator 37 includes a wave generation plug 371 and a deep groove ball bearing 372. The wave generation plug 371 has an elliptic outer periphery. The motor output shaft 48 is fixed to a center of the wave generation plug 371 by press-fitting. The deep groove ball bearing 372 includes flexible thin inner and outer races that permit a relative rotation between the outer periphery of the wave generation plug 371 and the inner periphery of the flexible external gear 36. When the wave generation plug 371 having the elliptic outer periphery is fitted to the inner race of the deep groove ball bearing 372, the inner race and the outer race of the deep groove ball bearing 372 also become elliptic. The wave generator 37 is fitted to the inner periphery of the flexible external gear 36 and the outer periphery of the wave generator 37 (the outer race of the deep groove ball bearing 372) is brought into contact with the inner periphery of the flexible external gear 36 throughout the entire range in the circumferential direction, by which the flexible external gear 36 (the cylindrical portion thereof) circular in an initial state is also deformed (distorted) into an elliptic shape in conformity with the outer race of the deep ball bearing 372.

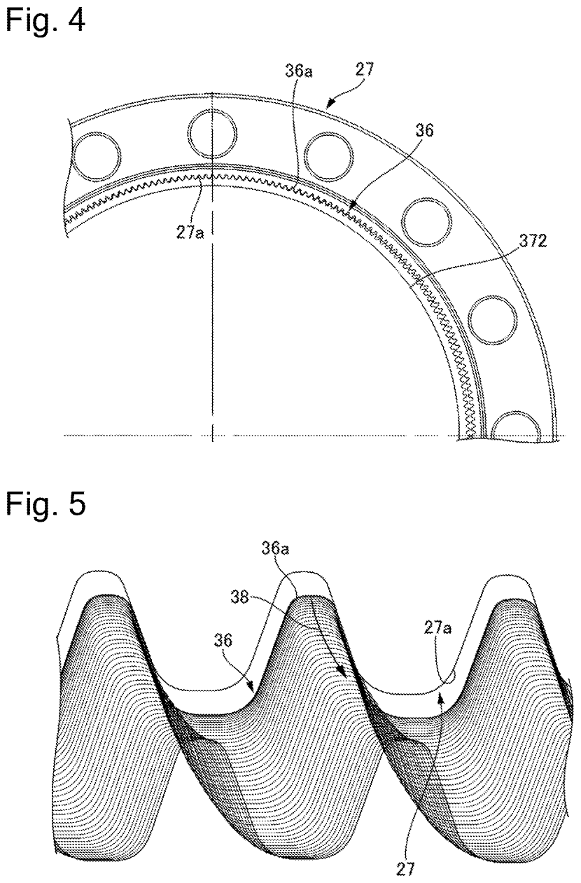

As illustrated in FIG. 4, the flexible external gear 36 and the rigid internal gear 27 are meshed with each other. The flexible external gear 36 having the elliptically distorted outer periphery has the number of teeth smaller than the rigid internal gear 27 by two teeth. Therefore, the internal teeth 27a and the external teeth 36a are meshed with each other with the aid of a difference in tooth pith on a major axis. On a minor axis, these teeth 27a and 36a have matching tooth pitches but do not interfere with each other because the flexible external gear 36 is distorted. Therefore, the flexible external gear 36 and the rigid internal gear 27 having the numbers of teeth different from each other by an even multiple can be meshed with each other as illustrated in FIG. 4. The cylindrical portion of the flexible external gear 36 with the external teeth 36a formed thereon is flexible, but the flange portion 36b is prohibited from being deformed from the circular shape to extract the output and is directly coupled with the second control shaft 11. Therefore, the flexible external gear 36 exhibits a shape flaring into an elliptic shape starting from the flange portion 36b toward an opening end portion of the cylindrical portion. A rotational movement of the flexible external gear 36 extracted from the deformation movement near the opening end portion is transmitted from the flange portion 36b to the second control shaft 11.

The rotational movement input from the motor output shaft 48 to the strain wave gearing apparatus 21 is converted into a reciprocating displacement movement in a direction perpendicular to the motor output shaft 48. More specifically, the inner and outer races of the deep groove ball bearing 372 have flexible thin structures. Balls of the deep groove ball bearing 372 have six degrees of freedom including a translation and a rotation, and therefore the inner race and the outer race have individually independent degrees of freedom in the circumferential direction. The shape of the inner race is transmitted to the outer race via the balls. The wave generation plug 371 is rotationally driven by the motor output shaft 48, and the inner race of the deep groove ball bearing 372, which is a fitting partner thereof, also follows it. Because the outer periphery of the rotating wave generation plug 371 is elliptic, the inner race has a radius different for each position. An increase and a reduction in the radius according to the rotation of the wave generation plug 371 (the inner race) is transmitted to the outer race via the balls. When being subjected to a restriction on the degree of freedom in the circumferential direction, the outer races carries out a deformation movement in synchronization with the above-described increase and reduction in the radius. Then, the outer race of the deep groove ball bearing 372 and the flexible external gear 36 are fitted to each other, and the flexible external gear 36 also carries out a deformation movement by following the above-described deformation movement of the outer race. This deformation movement causes a change in a mesh position on the major axis between rigid internal gear 27 and the flexible external gear 36. As a result, the teeth 27a and 36a are moved relative to each other in a direction perpendicular to the axis (a radial direction) when the tooth portions are enlarged and observed from a fixed point on the rigid internal gear 27. Then, due to a difference between a reference pitch circumferential length of the external teeth 36a of the flexible external gear 36 and a reference pitch circumferential length of the internal gear 27a of the rigid internal gear 27, a change (a rotational movement in the circumferential direction) occurs in the position of the flexible external gear 36 in the circumferential direction, and this rotational movement is superimposed on the above-described radial movement due to the change in the mesh position on the major axis. Therefore, the external teeth 36a of the flexible external gear 36 are moved radially inward along tooth surfaces of the internal teeth 27a of the rigid internal gear 27 as indicated by a direction 38 in FIG. 5.

In the following description, the shape of the outer periphery of the wave generator 37 will be described. First, an outline thereof will be described. With respect to the apparatus 21 in which the flexible external gear 36 and the rigid internal gear 27 are set according to arbitrarily selected tooth profiles and reference pitch circle diameters and the numbers of teeth determined based on a speed reduction ratio, basic mass properties that the shape of the outer periphery of the wave generator 37 should satisfy are hypothesized according to a module determined based on the reference pitch circle diameter and the number of teeth. Now, a condition that the shape of the outer periphery of the wave generator 37 should satisfy is that the external teeth 36a of the flexible external gear 36 can realize a continuous reciprocating movement keeping a constant cycle. A reference ellipse is hypothesized as a curve that satisfies this condition and satisfies a condition that prohibits a movement trajectory of the external tooth 36a from causing interference between it and the internal tooth 27a, which is the mesh partner, in the mesh between the external tooth 36a of the flexible external gear 36 and the internal tooth 27a of the rigid internal gear 27. The movement trajectory of the external tooth 36a of the flexible external gear 36 determined based on the hypothesized reference ellipse is acquired, and a trajectory line of this trajectory from a top of the mesh to K% is corrected so as to become a similar shape to the shape of the tooth surface of the internal tooth 27a. An elliptic curve after the correction is acquired by correcting the reference ellipse according to an amount of the correction made to the trajectory. Because a curvature radius is different between the original reference ellipse and the elliptic curve after the correction, the continuity of the shape of the outer periphery is maintained by connecting the curves via a clothoid curve therebetween. The elliptic curve formed in this manner is determined to be the shape of the outer periphery of the wave generator 37.

Now, details thereof will be described. First, a model is formulated regarding the movement trajectory of the external tooth 36a of the flexible external gear 36 when the shape of the outer periphery of the wave generator 37 matches the reference ellipse. Next, the above-described movement trajectory is corrected so as to further increase a mesh ratio between the internal teeth 27a of the rigid internal gear 27 and the external teeth 36a of the flexible external gear 36 (in other words, increase the number of meshed and contacting teeth), and this is reversely transferred to the shape of the outer periphery of the wave generator 37. By this process, the shape of the outer periphery of the wave generator 37 after the correction is acquired.

More specifically, an ellipse (x, y) expressed by the following equation, an equation (1) is set as the reference ellipse in cross section in a direction perpendicular to a rotational axis of the wave generator 37 (the rotational axis of the motor output shaft 48).

$$[ Equation 1 ]$$

$$( \begin{matrix}x \\ y\end{matrix} ) = ( \begin{matrix}( {r}_{n} - w ) cos θ \\ ( {r}_{n} + w ) sin θ\end{matrix} ) \qquad ( 1 )$$

In other words, the reference ellipse is expressed with use of a rotational angle θ of the wave generator 37 as a parameter, assuming that a major radius and a minor radius thereof are rn+w and rn−w, respectively, and the major axis thereof is placed on a y-axis direction. The major axis of the reference ellipse may be placed on an x-axis direction. In this equation, rn represents a radius of a reference circle, and corresponds to a dimension acquired by subtracting a radial thickness of the flexible external gear 36 from a reference pitch circle radius RDn of the flexible external gear 36 before it is deformed due to insertion of the wave generator 37 (in a standard state where the shape is a circle) (converted into the radius of the outer periphery of the wave generator 37). In other words, RDn is the reference pitch circle radius of the flexible external gear 36 when the shape of the reference circle is assumed to be the outer periphery of the wave generator 37.

In the equation (1), w represents an amount of a difference of the reference ellipse from the reference circle on the major axis and the minor axis thereof (an ellipse amount). A module m of the teeth 27a and 36a is determined based on a speed reduction ratio i required to the strain wave gearing apparatus 21 and a reference pitch circle radius RDS of the rigid internal gear 27, which corresponds to a reference constitution of the apparatus 21. More specifically, the number of teeth Z of the rigid internal gear 27 is determined based on the speed reduction ratio i. The module m is calculated by dividing a reference pitch circle diameter 2RDS of the rigid internal gear 27 by the number of teeth Z. The ellipse amount w is determined based on a relationship according to the following equation, an equation (2).

[Equation 2]

w>0.9 m (2)

As a premise, an addendum HA and a dedendum HF of the external tooth 36a from the reference pitch circle radius RDn in the flexible external gear 36 in the standard state are expressed by the following equations, equations (3) and (4) with use of the module m, respectively.

[Equation 3]

HA=0.8 m (3)

[Equation 4]

HF=1.0 m (4)

Further, w also represents an amount of a difference (an ellipse amount) on the major axis and the minor axis of the reference pitch circle of the flexible external gear 36 after it is deformed according to the reference ellipse due to the insertion of the wave generator 37 from the reference pitch circle of the flexible external gear 36 in the standard state. Determining w from the above-described equation (2) can establish an appropriate ellipse amount with which the flexible external gear 36 does not interfere with the rigid internal gear 27 on the minor axis and has a small tooth contact with the rigid internal gear 27 on the major axis. For example, even w>0.8 m allows the above-described interference to be avoided, but the above-described tooth contact can be further reduced by achieving w>0.9 m in the present embodiment.

When the shape of the outer periphery of the wave generator 37 is determined to be the reference ellipse in this manner, the movement trajectory of the external tooth 36a of the flexible external gear 36 is determined. The external tooth 36a in the standard state is deformed and moved due to the insertion of the wave generator 37 into the flexible external gear 36 at representative coordinates (xt, yt) of the external tooth 36a. Further, the destination to which the representative coordinates are deformed and moved changes per input rotation due to a rotation of the position of the major axis of the wave generator 37 along with the input. This deformation movement is accompanied by a movement of the representative coordinates due to the rotational movement of the flexible external gear 36 that is caused due to the difference between the reference pitch circumferential length of the external teeth 36a and the reference pitch circumferential length of the internal teeth. Therefore, superimposing these movements results in the movement trajectory of the external tooth 36a illustrated in FIG. 5 eventually. Then, when an angle (a rotational angle) ω of the rotational movement is expressed by the following equation, an equation (5), the actual movement trajectory of the external tooth 36a is modeled by the following equation, an equation (6).

$$\begin{matrix}[ Equation 5 ] & \\ ω = \frac{θ}{i} & ( 5 ) \\ [ Equation 6 ] & \\ ( \begin{matrix}{x}_{t} \\ {y}_{t}\end{matrix} ) = ( \sqrt{{x}_{t}^{′2} + {y}_{t}^{′2}} - w \cdot cos ( 2 θ ) ) ( \begin{matrix}cos ω & {}_{+}^{-} sin ω \\ {}_{-}^{+} sin ω & cos ω\end{matrix} ) ( \begin{matrix}cos ( {F}_{θ} ) \\ sin ( {F}_{θ} )\end{matrix} ) & ( 6 )\end{matrix}$$

Then, Fθ is expressed by the following equation, an equation (7).

$$[ Equation 7 ]$$

$${F}_{θ} = arcsin ( \frac{{r}_{n} - w \cdot {cos}^{α} θ}{\sqrt{{x}_{t}^{2} + {y}_{t}^{2}} - w \cdot cos ( 2 θ )} \cdot sin θ ) \qquad ( 7 )$$

Then, Fθ corresponds to an angle from the minor axis (the x axis) after the representative coordinates (xt, yt) of the external tooth 36a located at a position at the angle θ from the minor axis (the x axis) in the standard state are deformed and moved due to the insertion of the wave generator 37 into the flexible external gear 36. The inside of parentheses on the right side of the above-described equation (6) corresponds to a distance (a radius) of the representative coordinates (xt, yt) from the origin after the above-described deformation movement. Therefore, the above-described equation (6) corresponds to the movement trajectory of the representative coordinates (xt, yt) when the rotational movement is superimposed on the above-described deformation movement. A coefficient α in the above-described equation (7) represents a strength of the deformation according to, for example, the hardness of the material of the flexible external gear 36. For example, a is α=3.

The movement trajectory expressed by the above-described equation (6) is corrected with use of a tooth surface function of an employed tooth profile with respect to a trajectory from a position at which the external tooth 36a is meshed with the internal tooth 27a most deeply to arbitrary K%. For example, when tooth profile coordinates are expressed by a function of G(xg, yg), the coordinates (xt, yt) are corrected into (xt+xg, yt+yg). Then, the shape of the outer periphery of the wave generator 37 is corrected so as to be able to acquire the movement trajectory after the correction with use of an inverse transform of the above-described equation (6). More specifically, the corrected shape can be acquired by deriving β and ψ with use of the following equation, an equation (8) with respect to two variables of a polar coordinate system S (β, ψ) forming the shape of the outer periphery of the wave generator 37 after the correction (the corrected shape).

$$[ Equation 8 ]$$

$$β ( \begin{matrix}cos φ \\ sin φ\end{matrix} ) = \frac{1}{det} ( \begin{matrix}cos ω & {}_{+}^{-} sin ω \\ {}_{-}^{+} sin ω & cos ω\end{matrix} ) ( \begin{matrix}{x}_{t} + {x}_{g} \\ {y}_{t} + {y}_{g}\end{matrix} ) \qquad ( 8 )$$

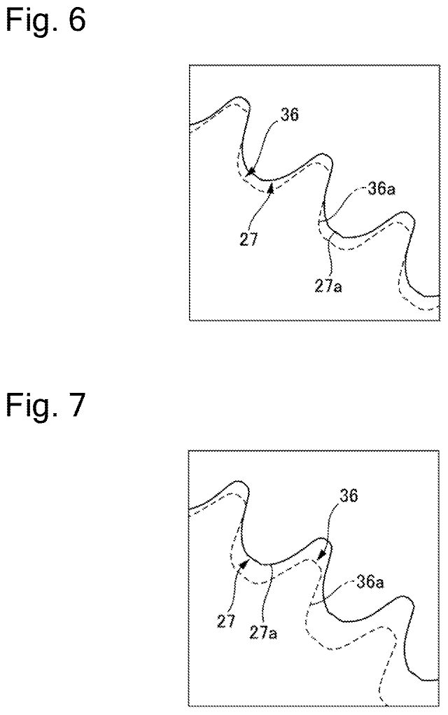

The corrected shape acquired in this manner is such a shape that the mesh ratio between the teeth 27a and 36a is higher than that before the correction illustrated in FIG. 7 (when the shape of the outer periphery of the wave generator 37 is the reference ellipse) regardless of the shapes of the internal tooth 27a and the external tooth 36a as illustrated in FIG. 6 (in other words, the number of external teeth 36a meshed and in contact with the internal teeth 27a increases even with the tooth profile kept the same).

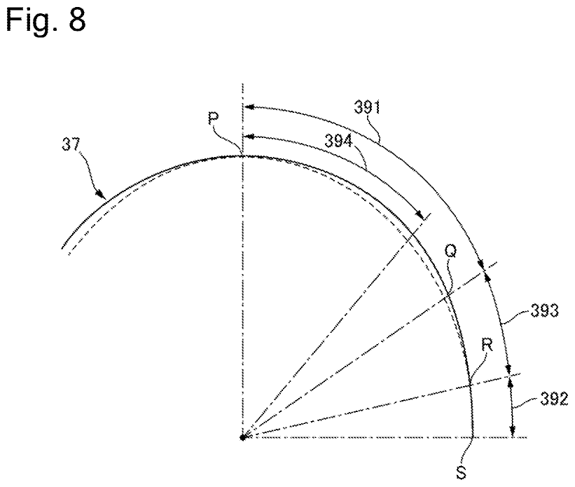

As illustrated in FIG. 8, it is preferable that a range where the corrected shape is set on the outer periphery of the wave generator 37 is placed in a region 391 circumferentially adjacent to an intersection point P with the major axis of the reference ellipse in light of increasing the mesh ratio. A position of an end point Q of the region 391 can be arbitrarily set. On the other hand, a region 392 circumferentially adjacent to an intersection point S with the minor axis of the reference ellipse on the outer periphery of the wave generator 37 may be any region that satisfies the above-described equation (2) on the minor axis and is shaped as a continuous curve where a pole is only a single point on the minor axis. Therefore, the shape of this region 392 may be any shape as long as these conditions are satisfied, and may be the reference ellipse or another curve.

Then, the use of the clothoid curve is appropriate according to the condition that a region 393 between the region 391 and the region 392 (between the end point Q of the region 391 to an end point R of the region 392) should be a curve smoothly connecting the curves to each other (so as not to cause discontinuity) on the outer periphery of the wave generator 37. For example, when μ represents a selected appropriate clothoid constant, ρ represents a curvature radius of the end point Q (x, y) of the region 391, and l represents a curve length of the region 393, the curve of the region 393 can be set with use of the following equation, an equation (9), which is a general equation expressing the clothoid curve, according to a condition satisfying the following equation, an equation (10).

$$\begin{matrix}[ Equation 9 ] & \\ ( \begin{matrix}x \\ y\end{matrix} ) = ( \begin{matrix}{\int }_{0}^{1 \text{/} μ} cos \frac{{θ}^{2}}{2} \cdot d θ \\ {\int }_{0}^{1 \text{/} μ} sin \frac{{θ}^{2}}{2} \cdot d θ\end{matrix} ) & ( 9 ) \\ [ Equation 10 ] & \\ ρ \cdot \vert = {μ}^{2} & ( 10 )\end{matrix}$$

From these calculations, the outer periphery of the wave generator 37 in cross section in the direction perpendicular to the rotational axis of the wave generator 37 is determined to be a curve acquired by combining the corrected shape in the region 391, the clothoid curve in the region 393, and the curve in the region 392. More specifically, the outer periphery of the wave generator 37 is an elliptic shape including the major axis in common with the reference ellipse indicated by a broken line and is different from the reference ellipse in terms of a shape of at least a part thereof in the circumferential direction (the regions 391 and 393). The outer periphery of the wave generator 37 is such an elliptic shape that the thickness is increased in at least the partial regions 391 and 393 between the intersection point P with the major axis and the intersection point S with the minor axis in the circumferential direction compared to the reference ellipse. This elliptic outer periphery is located a long distance away from the rotational axis compared to the reference ellipse in the regions 391 and 393 circumferentially adjacent to the intersection point P with the major axis (at least a partial region in the circumferential direction that does not include the intersection point P). Further, the outer periphery of the wave generator 37 has a smaller curvature radius than the reference ellipse in a predetermined region (a region 394) circumferentially adjacent to the intersection point P with the major axis. The region 391 circumferentially adjacent to the intersection point P with the major axis and the region 392 circumferentially adjacent to the intersection point S with the minor axis are smoothly connected to each other via the clothoid curve.

Next, advantageous effects will be described. The strain wave gearing apparatus 21 includes the rigid internal gear 27 having the plurality of teeth 27a on the inner periphery thereof, the cylindrical and flexible external gear 36 having the plurality of teeth 36a on the outer periphery thereof, and the wave generator 37 having the elliptic outer periphery. The outer periphery of the wave generator 37 contacts the inner periphery of the flexible external gear 36, by which the flexible external gear 36 is elliptically distorted, and a part of the external teeth 36a of the flexible external gear 36 is meshed with the rigid internal gear 27. The rotation of the wave generator 37 causes the position of the mesh to be moved in the circumferential direction, and this is output as a slowed rotation. Due to the nature that moves the position of the mesh by deforming the flexible external gear 36 in this manner, specifically understanding the movement trajectory of the external tooth 36a of the flexible external gear 36 is important to avoid the interference between the external tooth 36a and the internal tooth 27a of the rigid internal gear 27 and satisfy the function of the strain wave gearing apparatus 21, and is also important to determine the tooth profile that affects the performance of the strain wave gearing apparatus 21 at the same time. The shape of the outer periphery of the wave generator 37 determines the movement trajectory of the external tooth 36a, and constitutes the basis of the speed change mechanism of the strain wave gearing apparatus 21. In other words, the movement of the external tooth 36a, which transmits power, directly affects a torque capacity and torque transmission efficiency, which are basic performances of the strain wave gearing apparatus 21 as the speed reducer. Conventionally, an ellipse as one type of conic curve has been used as the shape of the outer periphery of the wave generator 37. This is because this shape can realize a continuous reciprocating movement of the external tooth 36a that keeps a constant cycle, can be most easily managed among non-circular shapes, can achieve an excellent rotational balance due to the symmetry of the shape, and can satisfy the movement conditions of the external tooth 36a. Then, the improvement of the above-described basic performances has been attempted by changing the shape of the tooth surface in contact according to the movement of the external tooth 36a in conformity with this reference ellipse. However, harmonizing the shape of the tooth surface with the movement of the external tooth 36a has necessitated a considerable correction to the tooth profile, but there has been a limit on an amount of the correction to the shape because of problems raised with processing and measurement thereof, and this has also led to a limit on the improvement of the basic performances of the strain wave gearing apparatus 21.

The strain wave gearing apparatus 21 according to the present embodiment solves the above-described inconvenience by setting the shape of the outer periphery of the wave generator 37 to a different elliptic shape from the reference ellipse. While the elliptic outer periphery of the wave generator 37 includes the major axis in common with the reference ellipse, the shape of at least a part thereof in the circumferential direction (the regions 391 and 393) is different from the reference ellipse. The elliptic outer periphery of the wave generator 37 is shaped in such a manner that that the higher mesh ratio is achieved between the teeth 27a and 36a than the reference ellipse regardless of the shapes of the teeth 27a and 36a of the rigid internal gear 27 and the flexible external gear 36. Therefore, the strain wave gearing apparatus 21 can improve the torque capacity, which is the basic performance, without correcting the shape of the tooth surface. More specifically, setting the shape of the outer periphery of the wave generator 37 to the curve acquired by correcting the ellipse allows the movement trajectory of the external tooth 36a to comply with the shape of the tooth profile of the internal tooth 27a, which is the mesh partner. As a result, an appropriate contact is maintained and an effective contact surface is increased between the tooth surfaces during the relative movement between the external tooth 36a and the internal tooth 27a, by which a load capability of the strain wave gearing apparatus 21 can be improved with a small correction to the tooth profile. Further, an effective mesh region is increased, by which an anti-ratcheting capability is also improved. The shape of the outer periphery of the wave generator 37 may be corrected so as to improve the torque transmission efficiency as well as the mesh ratio or instead of the mesh ratio. In the present embodiment, the tooth depth of the external tooth 36a is as short as 1.8 m (=HA+HF). Therefore, the present configuration can reduce a stress on a tooth root of the external teeth 36a and also achieve a reduction in the size of the flexible external gear 36. However, insufficiency of the torque capacity and prevention of the ratcheting phenomenon easily become problems. Therefore, it is effective to increase the mesh ratio by correcting the shape of the outer periphery of the wave generator 37 in light of the improvement of the torque capacity and the anti-ratcheting capability.

The outer periphery of the wave generator 37 has such an elliptic shape that the thickness is increased in at least the partial regions 391 and 393 between the intersection point P with the major axis and the intersection point S with the minor axis in the circumferential direction compared to the reference ellipse. In other words, this elliptic outer periphery is located the long distance away from the rotational axis compared to the reference ellipse in at least the partial regions 391 and 393 in the circumferential direction that do not include the intersection point P with the major axis. Therefore, the strain wave gearing apparatus 21 can easily promote the mesh between the external teeth 36a of the flexible external gear 36 and the internal teeth 27a of the rigid internal gear 27, thereby achieving the higher mesh ratio between these teeth 36a and 27a than the reference ellipse. Further, the elliptic shape held by the outer periphery of the wave generator 37 is located on the inner side with respect to a circle having a radius coinciding with the major axis in common with the reference ellipse. Therefore, the strain wave gearing apparatus 21 can reduce an amount by which the wave generator 37 to forcibly distort the flexible external gear 36, thereby improving the torque transmission efficiency. The shape of the outer periphery of the wave generator 37 may be set to a elliptic shape in which the thickness is reduced in at least a partial region between the intersection point P with the major axis and the intersection point S with the minor axis in the circumferential direction compared to the reference ellipse. In other words, the distance from the rotational axis may be reduced compared to the reference ellipse in at least a partial region in the circumferential direction that does not include the insertion point P with the major axis. In this case, the strain wave gearing apparatus 21 can easily reduce the mesh area between the teeth 36a and 27a, thereby improving the torque transmission efficiency.

In the present embodiment, the region located the long distance away from the rotational axis compared to the reference ellipse on the outer periphery of the wave generator 37 is the regions 391 and 393 circumferentially adjacent to the intersection point P with the major axis. Therefore, the strain wave gearing apparatus 21 can easily promote the mesh between the teeth 36a and 27a and achieve the higher mesh ratio between these teeth 36a and 27a than the reference ellipse, compared to when the region located the long distance away from the rotational axis compared to the reference ellipse is a region not circumferentially adjacent to the intersection point P with the major axis.

Further, the shape of the outer periphery of the wave generator 37 has the smaller curvature radius than the reference ellipse in the predetermined range (the region 394) circumferentially adjacent to the intersection point P with the major axis. Therefore, the distance from the rotational axis can be increased compared to the reference ellipse in the region circumferentially adjacent to the intersection point P with the major axis.

The shape of the outer periphery of the wave generator 37 does not have to include the minor axis in common with the reference ellipse. Further, the region 392 circumferentially adjacent to the intersection point S with the minor axis may be located either a long distance or a short distance away from the rotational axis compared to the reference ellipse on the outer periphery of the wave generator 37. The distance from the rotational axis to the region 392 that is longer than the reference ellipse allows the strain wave gearing apparatus 21 to further easily promote the mesh between the teeth 36a and 27a (on the major axis side). The distance from the rotational axis to the region 392 that is shorter than the reference ellipse allows the strain wave gearing apparatus 21 to further reliably avoid the interference between the teeth 36a and 27a on the minor axis, and also reduce the amount by which the wave generator 37 distorts the flexible external gear 36, thereby improving the torque transmission efficiency.

On the elliptic outer periphery of the wave generator 37, the region 391 circumferentially adjacent to the intersection point P with the major axis and the region 392 circumferentially adjacent to the intersection point S with the minor axis are smoothly connected to each other. The smooth connection between these regions 391 and 392 (without discontinuity generated therebetween) allows the strain wave gearing apparatus 21 to make the actuation of the wave generator 37 (the deep groove ball bearing 372) smooth, thereby improving durability of the wave generator 37. The region between these regions 391 and 392 (the region 393) is not limited to the clothoid curve. In the present embodiment, the above-described smooth connection can be easily realized due to the connection between these regions 391 and 392 via the clothoid curve.

### Other Embodiments

Having described the embodiment for implementing the present invention, the specific configuration of the present invention is not limited to the configuration of the embodiment, and the present invention also includes a design modification and the like thereof made within a range that does not depart from the spirit of the present invention. For example, the strain wave gearing apparatus according to the present invention is also applicable to an actuator of a valve timing control apparatus of an internal combustion engine discussed in Japanese Patent Application Public Disclosure No. 2015-1190, Japanese Patent Application Public Disclosure No. 2011-231700, and the like, an actuator of a variable steering angle mechanism capable of changing a turning angle with respect to a steering angle, and the like without being limited to the actuator of the variable compression ratio mechanism of the internal combustion engine. Further, the example in which the outer periphery of the wave generator is in contact with the inner periphery of the external gear throughout the entire range in the circumferential direction has been described in the present embodiment, but the strain wave gearing apparatus may be configured in such a manner that a part of the outer periphery of the wave generator in the circumferential direction is in contact with the inner periphery of the external gear.

The entire disclosure of Japanese Patent Application No. 2015-1190 including the specification, the claims, the drawings, and the abstract is incorporated herein by reference in its entirety.

The entire disclosure of Japanese Patent Application No. 2017-231700 including the specification, the claims, the drawings, and the abstract is incorporated herein by reference in its entirety.

### Technical Ideas Recognizable from Embodiment

Technical ideas (or technical solutions, the same applies hereinafter) recognizable from the above-described embodiment will be described below. (1) A strain wave gearing apparatus according to the present technical idea, in one configuration thereof, includes a rigid internal gear including a plurality of teeth on an inner periphery thereof, a cylindrical flexible external gear including a plurality of teeth on an outer periphery thereof, and a wave generator including a major axis in common with a reference ellipse and having an elliptic outer periphery different from the reference ellipse in terms of a shape of at least a part thereof in a circumferential direction. A contact of the outer periphery of the wave generator with an inner periphery of the external gear causes the external gear to be elliptically distorted and meshed with the internal gear at a part of the teeth of the external gear in a direction of the major axis, and a rotation of the wave generator causes a position of the mesh to be moved in the circumferential direction. In cross section in a direction perpendicular to a rotational axis of the wave generator, the elliptic outer periphery is located a long distance away from the rotational axis compared to the reference ellipse in at least a partial region in the circumferential direction that does not include an intersection point with the major axis.
(2) According to a further preferable configuration, in the above-described configuration, in cross section in the direction perpendicular to the rotational axis of the wave generator, the elliptic outer periphery is located the long distance away from the rotational axis compared to the reference ellipse in a region adjacent to the intersection point with the major axis in the circumferential direction.
(3) According to another preferable configuration, in any of the above-described configurations, in cross section in the direction perpendicular to the rotational axis of the wave generator, a region adjacent to the intersection point with the major axis in the circumferential direction and a region adjacent to an intersection point with a minor axis in the circumferential direction are connected via a clothoid curve on the elliptic outer periphery.
(4) Further, from another aspect, a strain wave gearing apparatus according to the present technical idea, in one configuration thereof, includes a rigid internal gear including a plurality of teeth on an inner periphery thereof, a flexible external gear including a barrel portion having a plurality of teeth on an outer periphery thereof, and a wave generator. The wave generator has an elliptic outer periphery and is disposed inside the external gear, and the wave generator elliptically distorts the external gear to cause the external gear to be partially meshed with the internal gear by contacting an inner periphery of the external gear throughout an entire range in a circumferential direction, and moves a position of the mesh in the circumferential direction by rotating. The wave generator has the elliptic outer periphery in which a thickness is increased in at least a partial region between an intersection point with a major axis and an intersection point with a minor axis in the circumferential direction compared to an ellipse expressed by the following equation, an equation (1), assuming that a major radius is rn+w, a minor radius is rn−w, and a rotational angle θ of the wave generator is used as a parameter in cross section in a direction perpendicular to a rotational axis of the wave generator.

$$[ Equation 1 ]$$

$$( \begin{matrix}x \\ y\end{matrix} ) = ( \begin{matrix}( {r}_{n} - w ) cos θ \\ ( {r}_{n} + w ) sin θ\end{matrix} ) \qquad ( 1 )$$

(5) Further, from another aspect, a strain wave gearing apparatus according to the present technical idea, in one configuration thereof, includes a rigid internal gear including a plurality of teeth on an inner periphery thereof, a cylindrical flexible external gear including a plurality of external teeth on an outer periphery thereof, and a wave generator including a major axis in common with a reference ellipse and having an elliptic outer periphery different from the reference ellipse in terms of a shape of at least a part thereof in a circumferential direction. The wave generator is disposed inside the external gear, and the wave generator elliptically distorts the external gear to cause the external gear to be meshed with the internal gear at a part of the external gear in a direction of the major axis, and moves a position of the mesh in the circumferential direction by rotating. The elliptic outer periphery is shaped in such a manner that a higher mesh ratio is achieved between the teeth of the external gear and the teeth of the internal gear than the reference ellipse regardless of shapes of the teeth of the internal gear and the external gear.
(6) Further, from another aspect, a strain wave gearing apparatus according to the present technical idea, in one configuration thereof, includes a rigid internal gear including a plurality of teeth on an inner periphery thereof, a cylindrical flexible external gear including a plurality of external teeth on an outer periphery thereof, and a wave generator including a major axis in common with a reference ellipse and having an elliptic outer periphery different from the reference ellipse in terms of a shape of at least a part thereof in a circumferential direction. A contact of the outer periphery of the, wave generator with an inner periphery of the external gear causes the external gear to be elliptically distorted and meshed with the internal gear at a part of the teeth of the external gear in a direction of the major axis, and a rotation of the wave generator causes a position of the mesh to be moved in the circumferential direction. The elliptic outer periphery has a smaller curvature radius than the reference ellipse in a predetermined region adjacent to an intersection point with the major axis in the circumferential direction.
(7) An actuator of a variable compression ratio mechanism for an internal combustion engine according to the present technical idea, in one configuration thereof, includes an electric motor, a control shaft coupled with the variable compression ratio mechanism of the internal combustion engine, and a strain wave gearing apparatus configured to slow down a rotational speed of the electric motor to transmit it to the control shaft. The strain wave gearing apparatus includes a rigid internal gear including a plurality of teeth on an inner periphery thereof, a cylindrical flexible external gear including a plurality of teeth on an outer periphery thereof, and a wave generator including a major axis in common with a reference ellipse and having an elliptic outer periphery different from the reference ellipse in terms of a shape of at least a part thereof in a circumferential direction. A contact of the outer periphery of the wave generator with an inner periphery of the external gear causes the external gear to be elliptically distorted and meshed with the internal gear at a part of the teeth of the external gear in a direction of the major axis, and a rotation of the wave generator causes a position of the mesh to be moved in the circumferential direction. In cross section in a direction perpendicular to a rotational axis of the wave generator, the elliptic outer periphery is located a long distance away from the rotational axis compared to the reference ellipse in at least a partial region in the circumferential direction that does not include an intersection point with the major axis.
(8) According to a further preferable configuration, in any of the above-described configurations, a region adjacent to the intersection point with the major axis and a region adjacent to the intersection point with the minor axis are smoothly connected to each other on the elliptic outer periphery.
(9) According to another preferable configuration, in any of the above-described configurations, a region adjacent to the intersection point with the major axis and a region adjacent to the intersection point with the minor axis are connected to each other via a clothoid curve on the elliptic outer periphery.
(10) According to another preferable configuration, in any of the above-described configurations, the following equation, an equation (2) is satisfied, when m represents a module of the teeth of the internal gear.

[Equation 2]

w>0.9 m (2)

The present invention is not limited to the above-described embodiment, and includes various modifications. For example, the above-described embodiment has been described in detail to facilitate better understanding of the present invention, and the present invention shall not necessarily be limited to the configuration including all of the described features. Further, a part of the configuration of some embodiment can be replaced with the configuration of another embodiment. Further, some embodiment can also be implemented with a configuration of another embodiment added to the configuration of this embodiment. Further, each embodiment can also be implemented with another configuration added, deleted, or replaced with respect to a part of the configuration of this embodiment.

The present application claims priority under the Paris Convention to Japanese Patent Application No. 2017-182310 filed on Sep. 22, 2017. The entire disclosure of Japanese Patent Application No. 2017-182310 filed on Sep. 22, 2017 including the specification, the claims, the drawings, and the abstract is incorporated herein by reference in its entirety.

### REFERENCE SIGNS LIST

A actuator of variable compression ratio mechanism of internal combustion engine
11 second control shaft (control shaft)
21 strain wave gearing apparatus (strain wave gearing speed reducer)
22 electric motor
27 rigid internal gear
27a internal tooth
36 flexible external gear
36a external tooth
37 wave generator

1. A strain wave gearing apparatus comprising:
a rigid internal gear including a plurality of teeth on an inner periphery thereof;
a cylindrical flexible external gear including a plurality of teeth on an outer periphery thereof; and
a wave generator including a major axis in common with a reference ellipse, the wave generator having an elliptic outer periphery different from the reference ellipse in terms of a shape of at least a part thereof in a circumferential direction,
wherein a contact of the outer periphery of the wave generator with an inner periphery of the external gear causes the external gear to be elliptically distorted and to be meshed with the internal gear at a part of the teeth of the external gear in a direction of the major axis, and a rotation of the wave generator causes a position of the mesh to be moved in the circumferential direction, and
wherein, in cross section in a direction perpendicular to a rotational axis of the wave generator, the elliptic outer periphery is located a long distance away from the rotational axis compared to the reference ellipse in at least a partial region in the circumferential direction that does not include an intersection point with the major axis.

2. The strain wave gearing apparatus according to claim 1, wherein, in cross section in the direction perpendicular to the rotational axis of the wave generator, the elliptic outer periphery is located the long distance away from the rotational axis compared to the reference ellipse in a region adjacent to the intersection point with the major axis in the circumferential direction.

3. The strain wave gearing apparatus according to claim 2, wherein, in cross section in the direction perpendicular to the rotational axis of the wave generator, a region adjacent to the intersection point with the major axis in the circumferential direction and a region adjacent to an intersection point with a minor axis in the circumferential direction are connected via a clothoid curve on the elliptic outer periphery.

4. A strain wave gearing apparatus comprising:
a rigid internal gear including a plurality of teeth on an inner periphery thereof;
a flexible external gear including a barrel portion having a plurality of teeth on an outer periphery thereof; and
a wave generator,
wherein the wave generator has an elliptic outer periphery and is disposed inside the external gear, and the wave generator elliptically distorts the external gear to cause the external gear to be partially meshed with the internal gear by contacting an inner periphery of the external gear throughout an entire range in a circumferential direction, and moves a position of the mesh in the circumferential direction by rotating, and
wherein the wave generator has the elliptic outer periphery in which a thickness is increased in at least a partial region between an intersection point with a major axis and an intersection point with a minor axis in the circumferential direction compared to an ellipse expressed by the following equation, an equation (1), assuming that a major radius is rn+w, a minor radius is rn−w, and a rotational angle θ of the wave generator is used as a parameter in cross section in a direction perpendicular to a rotational axis of the wave generator.
$$[ Equation 1 ]$$
$$( \begin{matrix}x \\ y\end{matrix} ) = ( \begin{matrix}( {r}_{n} - w ) cos θ \\ ( {r}_{n} + w ) sin θ\end{matrix} ) \qquad ( 1 )$$

5. The strain wave gearing apparatus according to claim 4, wherein a region adjacent to the intersection point with the major axis and a region adjacent to the intersection point with the minor axis are smoothly connected to each other on the elliptic outer periphery.

6. The strain wave gearing apparatus according to claim 4, wherein a region adjacent to the intersection point with the major axis and a region adjacent to the intersection point with the minor axis are connected to each other via a clothoid curve on the elliptic outer periphery.

7. The strain wave gearing apparatus according to claim 4, wherein the following equation, an equation (2) is satisfied, when m represents a module of the teeth of the internal gear.
[Equation 2]
w>0.9 m (2)

8. An actuator of a variable compression ratio mechanism for an internal combustion engine, the actuator comprising:
an electric motor;
a control shaft coupled with the variable compression ratio mechanism for the internal combustion engine; and
a strain wave gearing apparatus configured to slow down a rotational speed of the electric motor to transmit it to the control shaft,
wherein the strain wave gearing apparatus includes
a rigid internal gear including a plurality of teeth on an inner periphery thereof,
a cylindrical flexible external gear including a plurality of teeth on an outer periphery thereof, and
a wave generator including a major axis in common with a reference ellipse, the wave generator having an elliptic outer periphery different from the reference ellipse in terms of a shape of at least a part thereof in a circumferential direction,
wherein a contact of the outer periphery of the wave generator with an inner periphery of the external gear causes the external gear to be elliptically distorted and to be meshed with the internal gear at a part of the teeth of the external gear in a direction of the major axis, and a rotation of the wave generator causes a position of the mesh to be moved in the circumferential direction, and
wherein, in cross section in a direction perpendicular to a rotational axis of the wave generator, the elliptic outer periphery is located a long distance away from the rotational axis compared to the reference ellipse in at least a partial region in the circumferential direction that does not include an intersection point with the major axis.

9. A strain wave gearing apparatus comprising:
a rigid internal gear including a plurality of teeth on an inner periphery thereof;
a cylindrical flexible external gear including a plurality of external teeth on an outer periphery thereof; and
a wave generator including a major axis in common with a reference ellipse, the wave generator having an elliptic outer periphery different from the reference ellipse in terms of a shape of at least a part thereof in a circumferential direction,
wherein the wave generator is disposed inside the external gear, and the wave generator elliptically distorts the external gear to cause the external gear to be meshed with the internal gear at a part of the external gear in a direction of the major axis, and moves a position of the mesh in the circumferential direction by rotating, and
wherein the elliptic outer periphery is shaped in such a manner that a higher mesh ratio is achieved between the teeth of the external gear and the teeth of the internal gear than the reference ellipse regardless of shapes of the teeth of the internal gear and the external gear.

10. A strain wave gearing apparatus comprising:
a rigid internal gear including a plurality of teeth on an inner periphery thereof;
a cylindrical flexible external gear including a plurality of external teeth on an outer periphery thereof; and
a wave generator including a major axis in common with a reference ellipse, the wave generator having an elliptic outer periphery different from the reference ellipse in terms of a shape of at least a part thereof in a circumferential direction,
wherein a contact of the outer periphery of the wave generator with an inner periphery of the external gear causes the external gear to be elliptically distorted and to be meshed with the internal gear at a part of the teeth of the external gear in a direction of the major axis, and a rotation of the wave generator causes a position of the mesh to be moved in the circumferential direction, and
wherein the elliptic outer periphery has a smaller curvature radius than the reference ellipse in a predetermined region adjacent to an intersection point with the major axis in the circumferential direction.
